(19) United States
(12) Patent Application Publication
(10) Pub. No.: US 2025/0387208 A1
(43) Pub. Date: Dec. 25, 2025

(54) Method For Determining An Internal Structure Of A Dental Prosthesis Base Having At Least One Blood Vessel Simulation, Method For The Production Of A Dental Prosthesis Base, Dental Prosthesis Base, Data-Processing Device, Computer Program And Computer-Readable Medium

(71) Applicant: Ivoclar Vivadent AG, Schaan (LI)

(72) Inventors: Hendrik John, Buchs (CH); Mathias Vetsch, Grabs (CH)

(21) Appl. No.: 19/247,411

(22) Filed: Jun. 24, 2025

(30) Foreign Application Priority Data
Jun. 25, 2024 (EP) 24184392.9

(51) Int. Cl. A61C 13/34; A61C 13/00; G09B 23/28

(52) U.S. Cl. CPC A61C 13/34; A61C 13/0004; G09B 23/283

(57) ABSTRACT

A method for determining an internal structure of a dental prosthesis base having at least one blood vessel simulation. The method includes obtaining outer shell data which describe an outer shell of the dental prosthesis base. The method includes obtaining blood vessel data which describe the at least one blood vessel simulation. The method includes combining the outer shell data and the blood vessel data to form internal structure data, wherein the internal structure data describe an arrangement of the at least one blood vessel simulation within the outer shell of the dental prosthesis base. A method for the production of a dental prosthesis base is included. A dental prosthesis base with an outer shell and an internal structure is included, using the method herein. A data-processing device, a computer program and a computer-readable medium are also presented.

### CROSS-REFERENCE TO RELATED APPLICATIONS

This application claims priority to European Patent Application No. 24184392.9 filed on Jun. 25, 2024, the disclosure of which is incorporated herein by reference in its entirety.

### TECHNICAL FIELD

The present invention relates to a method for determining an internal structure of a dental prosthesis base having at least one blood vessel simulation.

In addition, the invention relates to a method for the production of a dental prosthesis base with a predetermined outer shell and having at least one blood vessel simulation.

The invention also relates to a dental prosthesis base with an outer shell and an internal structure.

Furthermore, the invention relates to a data-processing device, a computer program and a computer-readable medium.

### SUMMARY

In the context of the present invention, a dental prosthesis base is understood to be that part of a dental prosthesis which does not serve to simulate teeth. Therefore, the dental prosthesis base substantially simulates gums. Replacement teeth of a dental prosthesis do not belong to the dental prosthesis base. The dental prosthesis base can be part of a full dental prosthesis or a partial dental prosthesis.

In the field of dental prosthesis production, it is known to produce the dental prosthesis base from synthetic material. In order to simulate natural gums in a manner as true to the original as possible, the synthetic material from which the dental prosthesis base is produced can be dyed in a color corresponding to the natural gum color. In order to simulate blood vessels which are present in natural gums, a fiber material—which includes for example a plurality of reddish fibers—can be added to the synthetic material from which the dental prosthesis base is produced. The fibers thus represent—individually or grouped together—one or more blood vessel simulations.

The object of the present invention is to further improve the level to which a dental prosthesis base is true to the original, i.e. to achieve a natural-looking appearance for the dental prosthesis base. In other words, it should become possible to produce a dental prosthesis base, the appearance of which approximates natural gums as closely as possible.

The object is achieved by a method for determining an internal structure of a dental prosthesis base having at least one blood vessel simulation. The method comprises:
obtaining outer shell data which describe an outer shell of the dental prosthesis base,
obtaining blood vessel data which describe at least one blood vessel simulation, and
combining the outer shell data and the blood vessel data to form internal structure data, wherein the internal structure data describe an arrangement of the at least one blood vessel simulation within the outer shell of the dental prosthesis base.

This method is based on the idea of achieving the most natural-looking appearance possible for a dental prosthesis base not only by means of an outer shell which is as natural-looking as possible, but also by utilizing the internal structure of the dental prosthesis base to achieve the most natural-looking appearance possible. Therefore, in addition to the natural-looking simulation of the outer shell an internal structure of the dental prosthesis base is also to be selected in accordance with the present invention such that the level to which the dental prosthesis base is true to the original is increased overall. The fundamental concept here is that a dental prosthesis base it typically transparent or translucent at least in sections. Therefore, the internal structure can contribute to the external appearance. In this context, the outer shell data describe the outer shell of the dental prosthesis base preferably in virtual space. The blood vessel data describe the at least one blood vessel simulation indirectly or directly and preferably likewise in virtual space. The blood vessel data describe at least an outer shape of at least one blood vessel simulation. This can be effected directly, i.e. the blood vessel data can contain a specific description of the outer shape of the least one blood vessel simulation. Preferably, the outer shape is described in three spatial dimensions. Alternatively, the blood vessel data can describe the blood vessel simulation indirectly. In this context, the blood vessel data contain a set of layer data, wherein each element of the set of layer data describes a planar section of the blood vessel simulation. In total, i.e. taken together, all the elements of the set of layer data likewise describe an outer shape of the blood vessel simulation. Another alternative of indirectly describing an outer shape of at least one blood vessel simulation resides in providing parameters of this shape. For the simplest case that a blood vessel simulation is to have the shape of a circular cylinder, the blood vessel data can, for example, describe a diameter and a height of this circular cylinder. In all of said alternatives, an outer shape of at least one blood vessel simulation is thus described by means of data. Therefore, the outer shell data and the blood vessel data can preferably be combined in virtual space to form internal structure data. As already mentioned, the internal structure data contain a description of the at least one blood vessel simulation in the interior of the outer shell of the dental prosthesis base. In other words, the internal structure data describe a dental prosthesis base which comprises a blood vessel simulation which is located within the outer shell. Since natural gums also contain blood vessels, an internal structure of the dental prosthesis base can be determined by means of the method in accordance with the invention, which leads to an extremely natural-looking appearance. At the same time, the method in accordance with the invention is comparatively simple and can easily be implemented in particular within CAD software or within CAM software,

In conjunction with the present invention, the outer shell data can be determined in a patient-specific manner. For example, the outer shell data are based upon scan data describing an oral situation, i.e. the inside of the patient's mouth. Such scan data can be generated by means of an intraoral scanner. On the basis of such scan data, the outer shell data can be modelled within the dental CAD software and, if necessary or desired, adapted in the dental CAM software. The outer shell data describe the outer shell of the dental prosthesis base in virtual space.

It is understood that the outer shell data, owing to the description of the outer shell of the dental prosthesis base, at least indirectly also describe a volume of the dental prosthesis base which is delimited by the outer shell. The description of a delimitation of a volume represents one manner of describing a volume which is efficient in terms of data technology.

In particular, the method in accordance with the invention is automated, partially automated and/or computer-assisted. This means that the internal structure can be determined substantially without human activity. The method in accordance with the invention for determining an internal structure of a dental prosthesis base can therefore be a computer-implemented method.

It is understood that the method in accordance with the invention can be used both for partial dental prostheses and for full dental prostheses comprising a dental prosthesis base.

According to one embodiment, combining the outer shell data and the blood vessel data to form internal structure data includes a Boolean operation. This means that the outer shell data and the blood vessel data are combined using at least one Boolean operation. Alternatively or in addition, combining the outer shell data and the blood vessel data to form internal structure data includes exclusively using the blood vessel data within the outer shell of the dental prosthesis base described by the outer shell data. As already mentioned, the blood vessel data describe at least one blood vessel simulation. Alternatively, the blood vessel data can describe a plurality of blood vessel simulations which are preferably arranged in three-dimensional space. In other words, the blood vessel data describe a plurality of blood vessel simulations which are arranged within a volume. Preferably, intermediate spaces between the individual blood vessel simulations are empty spaces. In such a case, the combining by means of a Boolean operation can be effected in a plurality of steps. In a first step, those elements of the blood vessel data which describe blood vessel simulations or sections of blood vessel simulations which would lie outside the outer shell can be eliminated or ignored. This means that the outer shell described by the outer shell data is placed virtually within the volume within which the blood vessel simulations are arranged. Then, this volume can be separated into two partial volumes, wherein one partial volume lies within the outer shell and another partial volume lies outside the outer shell. As a result of this step, reduced blood vessel data are thus obtained. In a further step, the reduced blood vessel data can then be subtracted from the outer shell data, i.e. from the volume delimited by means of the outer shell. As a result, the volume delimited by the outer shell has, throughout, empty spaces at those locations where blood vessel simulations are later to be arranged. These data can be referred to as reduced outer shell data. In a subsequent step, the reduced blood vessel data and the reduced outer shell data can then be united in order to generate the internal structure data. In this manner it is ensured that the internal structure data merely describe blood vessel simulations within the outer shell. At the same time it is ensured that for every point or voxel of the internal structure of the dental prosthesis base, it is clearly established whether it belongs to a blood vessel simulation or to a section of the dental prosthesis base, which simulates a section of gum which does not represent any blood vessel simulation. Therefore, internal structure data which describe blood vessel simulations within the outer shell can be generated easily and reliably. Furthermore, the generation of the internal structure data can be easily automated and thus executed e.g. by means of a CAD system and/or a CAM system.

In another case in which the combining is effected by means of a Boolean operation, those elements of the blood vessel data which describe blood vessel simulations or sections of blood vessel simulations which would lie outside the outer shell are likewise eliminated or ignored in a first step. The blood vessel data can again describe a plurality of blood vessel simulations which are arranged within a volume. Preferably, intermediate spaces between the individual blood vessel simulations are again empty spaces. This means that in the first step the outer shell described by the outer shell data is placed virtually within the volume within which the blood vessel simulations are arranged. Then, this volume can be separated into two partial volumes, wherein one partial volume lies within the outer shell and another partial volume lies outside the outer shell. As a result of this partial step, reduced blood vessel data are thus obtained. The internal structure is then defined jointly by the reduced blood vessel data and the volume described by means of the outer shell data. This means that the internal structure data contains a combination of the reduced blood vessel data and the outer shell data. However, in this variant, the blood vessel simulations described by the reduced blood vessel data overlap the volume described by the outer shell data. Therefore, the internal structure data in this case also contain prioritization data which describe a prioritization of those sub-volumes which are used for blood vessel simulation and thus are described by the reduced blood vessel data over those sub-volumes which are used to simulating the rest of the gums. This means that a point or voxel of the internal structure which is allocated to a blood vessel simulation, i.e. is described by the reduced blood vessel data, and is also a component of the volume described by the outer shell data is defined by means of the prioritization data clearly as a component of a blood vessel simulation. It is thus also ensured in this variant that for every point of the internal structure of the dental prosthesis base, it is clearly established whether it belongs to a blood vessel simulation or to a section of the dental prosthesis base, which simulates a section of gum which does not contain any blood vessels. Therefore, internal structure data which describe blood vessel simulations within the outer shell can be generated easily and reliably. Furthermore, the generation of the internal structure data can be easily automated and thus executed e.g. by means of a CAD system and/or a CAM system.

The alternative in which the blood vessel data are used exclusively within the outer shell of the dental prosthesis base described by the outer shell data can be described in a simplified manner to the effect that the interior of the outer shell is filled with blood vessel simulations during the combination of the outer shell data and the blood vessel data. This is effected virtually, i.e. purely through data processing. In this alternative, the blood vessel simulations described by the blood vessel data are thus directly arranged exclusively within the outer shell. For this purpose, an anchor point for each blood vessel simulation can be defined within the outer shell. Then, a blood vessel simulation can be allocated to each anchor point and be positioned relative to the anchor point within the outer shell. In a first example, the anchor points are determined by means of a regular, three-dimensional grid. In a second example, the anchor points are determined by means of an irregular, three-dimensional grid. In a third example, the anchor points are arranged randomly within the outer shell. The blood vessel simulations for all of the anchor points can be the same or different, as will be explained in detail hereinafter. According to the two alternatives, internal structure data which describe blood vessel simulations within the outer shell can be generated easily and reliably. Furthermore, the two alternatives can be easily automated and thus executed e.g. by means of a CAD system and/or a CAM system.

The blood vessel data can contain at least one geometric parameter which describes a geometry of the blood vessel simulation. Alternatively or in addition, the blood vessel data can contain at least one method parameter which describes a process for creating the blood vessel simulation. For the case that the blood vessel data contain at least one geometric parameter, the blood vessel data can be referred to in a simplified manner also as a template or model. In this case, the combination of the outer shell data and the blood vessel data is merely the positioning of the least one blood vessel simulation, which corresponds to the template described by the blood vessel data, within the outer shell which is described by the outer shell data. For the case that the blood vessel data contain at least one method parameter, the blood vessel data contain a rule or a system of rules, the execution of which leads to a description of the at least one blood vessel simulation. For example, in this context method parameters can be contained within the blood vessel data which describe an extrusion method. This proceeds preferably virtually. A blood vessel simulation can be described for example by virtue of the fact that a cross-section is predetermined which it to be extruded along a predetermined path. In addition, a length can be predetermined for the extrusion. In this context, the path can comprise one or more bends. It is understood that such an extrusion method can also be executed for a plurality of starting points within the outer shell described by the outer shell data. In addition, boundary conditions can be predetermined which relate, for example, to minimum distances between the plurality of starting points. Overall, blood vessel simulations can be precisely and reliably described in this manner.

According to one variant, the at least one blood vessel simulation is described as a cross-section running along a path in the manner of an extrusion. This can be combined with the variant in which the blood vessel data contain at least one geometric parameter and also with the variant in which the blood vessel data contain at least one method parameter. In both cases, the blood vessel simulation can be described in a simple and efficient manner.

The blood vessel data can describe a plurality of blood vessel simulations. The blood vessel simulations can be distributed in three dimensions. Preferably, in that case the individual blood vessel simulations are also described in three dimensions. Furthermore, the distribution in three dimensions can be effected in accordance with at least one rule. In such a case, this is also referred to as a pattern, more precisely a 3D pattern. For example, some or all of the plurality of blood vessel simulations may be identical in their own right. In this case, the individual blood vessel simulations thus represent duplicates which are distributed in three dimensions. Optionally, a spatial orientation of the duplicates can be varied. Alternatively, it is also possible for each blood vessel simulation of the plurality of blood vessel simulations to be different. Mixed forms are also possible. In this context, two or more groups of blood vessel simulations can be described by means of the blood vessel data, wherein the blood vessel simulations belonging to the same group are identical in their own right. However, blood vessel simulations belonging to different groups have a different geometry. It is also possible to create different blood vessel simulations by varying one or more geometric parameters. For example, in this context a scaling and/or length of the blood vessel simulations can be varied. The distribution of the blood vessel simulations can also contain a random element. In other words, the distribution of the blood vessel simulations in three dimensions can be random. As a whole, a natural-looking appearance and a natural-looking distribution of the blood vessel simulations is produced.

In one example, a so-called Poisson Disk Sampling method is used for the spatial distribution of the blood vessel simulations. In such a method, the blood vessel simulations are arranged randomly in virtual three-dimensional space, wherein, however, a predetermined minimum distance is retained. In the present case, the minimum distance is 3 mm to 10 mm. Preferably, the minimum distance is 4 mm, 5 mm or 6 mm.

In one example, the method further comprises:
obtaining density information which describes a spatial packing density of the blood vessel simulations, and
combining the density information and the blood vessel data so that the plurality of blood vessel simulations are distributed in three dimensions with the spatial packing density.

In this manner, a plurality of blood vessel simulations can be arranged quickly and simply. Furthermore, by means of the density information the spatial arrangement of the blood vessel simulations can be influenced such that as a whole a natural-looking appearance of the dental prosthesis base is produced. It is understood that the density information can be established. Alternatively, the density information can be variable, i.e. different density information can be used for different internal structure data which are used e.g. for different dental prosthesis bases.

According to one exemplified embodiment, the method further includes obtaining scaling information and scaling of at least one dimension of the at least one blood vessel simulation described by the blood vessel data on the basis of the scaling information. In other words, the scaling information describes a size or extent of a blood vessel simulation which relates to at least one dimension of the blood vessel simulation. Therefore, a size of the blood vessel simulation can be adapted to the relevant dental prosthesis base by means of the scaling information. Therefore, a natural-looking simulation of a blood vessel can be achieved. Furthermore, the scaling information can be used, in a case in which a plurality of blood vessel simulations are provided, in order to vary these blood vessel simulations. In this manner, blood vessel simulations which are true to the original can also be created.

In conjunction with the obtained scaling information, it is possible to scale all the dimensions of a blood vessel simulation uniformly. This corresponds to an enlargement or a reduction. Alternatively, it is possible to scale fewer than all the dimensions, e.g. only one dimension. This results in a distortion of the blood vessel simulation, e.g. in a compression or stretching. It is understood that in a case in which a plurality of blood vessel simulations are provided, the aforementioned alternatives can also be combined, i.e. at least one blood vessel simulation can be generated by enlarging or reducing another blood vessel simulation or a model. In addition, at least one blood vessel simulation can be generated by distorting another blood vessel simulation or a model. As a whole, a plurality of blood vessel simulations can thus be created which as a result are different in shape but are based on merely one or a few blood vessel simulations, wherein the last-named blood vessel simulation can be referred to as a template or model. This is thus efficient in terms of data technology and at the same time leads to a natural-looking appearance of the dental prosthesis base.

The method can further comprise:
allocating color information to the at least one blood vessel simulation described by the blood vessel data, and/or
allocating color brightness information to the at least one blood vessel simulation described by the blood vessel data, and/or
allocating material information to the at least one blood vessel simulation described by the blood vessel data, and/or
allocating translucency information to the at least one blood vessel simulation described by the blood vessel data.

This means that color information and/or color brightness information and/or material information and/or translucency information can be allocated to the at least one blood vessel simulation. For the case that a plurality of blood vessel simulations are provided, color information and/or color brightness information and/or material information and/or translucency information can be allocated to each blood vessel simulation. In so doing, the color information and/or the color brightness information and/or the material information and/or the translucency information can be the same for all the blood vessel simulations. Alternatively, the color information and/or the color brightness information and/or the material information and/or the translucency information are different for each blood vessel simulation. According to another alternative, groups of blood vessel simulations have the same color information and/or color brightness information and/or material information and/or translucency information, wherein different color information and/or different color brightness information and/or different material information and/or different translucency information are allocated to different groups. In this way, the internal structure of the dental prosthesis base is defined more precisely. The allocation of the material information and/or color information and/or color brightness information and/or translucency information produces a natural-looking appearance of the dental prosthesis base. As a whole, in this way, an internal structure of the dental prosthesis base can be defined in detail so that the dental prosthesis base has a natural-looking appearance. It is understood that the blood vessel simulation differs from the remaining sections of the dental prosthesis base, i.e. from the sections of the dental prosthesis base which are not blood vessel simulations, in terms of the color information, i.e. in terms of the color, and/or the color brightness information, i.e. the brightness of the color, and/or in terms of the material information, i.e. in terms of the material used, and/or in terms of the translucency information, i.e. in terms of the translucency.

For example, in the present case the color information relates to a color value in a LAB color model. In that case, the color brightness information relates to a brightness value in the LAB color model.

It is further noted that the term translucency is reciprocal for the term opacity and, for the sake of simplicity, the term translucency is predominantly used in the present case.

Preferably, a color which is the darkest color within the color range used for the dental prosthesis base is allocated to the at least one blood vessel simulation, described by the blood vessel data, by means of the color information and/or by means of the color brightness information. In this manner, a particularly natural outer appearance of the dental prosthesis base is produced.

Preferably, a translucency which is the lowest translucency within the translucency range used for the dental prosthesis base is allocated to the at least one blood vessel simulation, described by the blood vessel data, by means of the translucency information. In other words, the highest available opacity is allocated to the at least one blood vessel simulation. In this manner, a particularly natural outer appearance of the dental prosthesis base is produced.

It is also possible for the method to additionally comprise:
obtaining block-out data which describe at least one blood vessel-free section within the outer shell of the dental prosthesis base, and
combining the outer shell data and the blood vessel data to form internal structure data for sections within the outer shell of the dental prosthesis base and outside the at least one blood vessel-free section described by the block-out data.

Therefore, regions of the dental prosthesis base in which blood vessel simulations are not intended to be provided can be described by means of the block-out data. In this manner, a particularly natural appearance of the dental prosthesis base can be produced since natural gums also contain sections in which blood vessels are not present. This can be imitated utilizing the block-out data. For example, a section on a surface of the dental prosthesis base can thus be kept free of blood vessel simulations. For example, a blood vessel simulation may not be provided in a layer adjoining the surface of the dental prosthesis base. This layer has e.g. a thickness of 250 μm or less, in particular of 200 μm or less. Such a layer represents a natural-looking simulation of a mucous membrane present on natural gums, which membrane typically does not contain any blood vessels.

According to one embodiment, the method further comprises:
obtaining sub-volume data which describe a section of an interior of the outer shell of the dental prosthesis base described by the outer shell data,
combining the outer shell data, the sub-volume data and the blood vessel data to form internal structure data, wherein the internal structure data describe an arrangement of the at least one blood vessel simulation within the section of the interior of the outer shell of the dental prosthesis base described by the sub-volume data.

In this manner, blood vessel simulations can be defined which are limited to the section of an interior of the outer shell described by the sub-volume data. The at least one blood vessel simulation can thus be provided in a locally limited manner. Furthermore, the present method can be executed multiple times for a dental prosthesis base, wherein for each execution of the method, different sub-volume data are used, i.e. each execution relates to a different section of an interior of the outer shell. Therefore, blood vessel simulations of different types can be defined for different sub-volumes. This makes allowance for the fact that even in natural gums the blood vessels in different sub-volumes are formed differently, e.g. so-called free gingiva and attached gingiva. Therefore, a natural-looking appearance of the dental prosthesis base is achieved.

Obtaining blood vessel data can include selecting the blood vessel data from a plurality of blood vessel data alternatives, wherein each of the blood vessel data alternatives describes at least one blood vessel simulation. In this context, the blood vessel data alternatives can be provided in the form of a library. In this manner, a plurality of blood vessel data alternatives can be provided simply and reliably. The blood vessel simulations described by the blood vessel data alternatives are different from each other. The use of different blood vessel simulations leads to a particularly natural-looking appearance of the dental prosthesis base. The different blood vessel simulations can be selected by a user. Alternatively, it is possible for the blood vessel data alternatives and thus the different blood vessel simulations to be selected utilizing a random component. Blood vessel data alternatives of all blood vessel data or of a subset of available blood vessel data alternatives can be used. As already explained, each blood vessel data alternative contains a description of a blood vessel simulation preferably in three spatial dimensions. As a whole, in this manner an internal structure of a dental prosthesis base can be provided which leads to a realistic, i.e. natural-looking, appearance.

The object is additionally solved by a method for the production of a dental prosthesis base with a predetermined outer shell and having at least one blood vessel simulation. The method comprises:
determining an internal structure of the dental prosthesis base by means of the method in accordance with the invention in order to determine an internal structure of a dental prosthesis base, and
fabricating the dental prosthesis base with the determined internal structure, wherein the at least one blood vessel simulation is fabricated by means of a substance which differs in terms of at least one property selected from material, color, color brightness and translucency from the substance by means of which the remaining sections of the dental prosthesis base are fabricated.

Thus, with respect to material, color, color brightness and/or translucency, different substances are used to fabricate the at least one blood vessel simulation and to fabricate the remaining sections of the internal structure of the dental prosthesis base. Such a dental prosthesis base is characterized by an extremely natural-looking appearance. At the same time, the method in accordance with the invention is comparatively simple and can easily be implemented in particular within a CAD-CAM workflow.

Within the method for the production of a dental prosthesis base, an additive fabricating method can be used to fabricate the dental prosthesis base with the determined internal structure. An alternative name for such a fabricating method is a generative fabricating method. In simple terms, the dental prosthesis base can be produced by means of a 3D printing method. In this manner, the dental prosthesis base can be produced with the determined internal structure in a reliable and precise manner. In particular, additive fabricating methods are suitable for producing a patient-specific dental prosthesis base. It is understood that for such an additive fabricating method, the sub-volumes of the dental prosthesis base which are allocated to the blood vessel simulation and the sub-volumes which are allocated to the rest of the gum must be free of overlap. Therefore, for each point or each voxel of the internal structure it is clear whether it is used for simulating a blood vessel or for simulating a blood vessel-free gum section. Alternatively, i.e. when the sub-volumes of the dental prosthesis base which are allocated to the blood vessel simulation and the sub-volumes which are allocated to the rest of the gum are not free of overlap, the sub-volumes which are used for blood vessel simulation must be prioritized over the sub-volumes which are used for simulating the rest of the gum. Therefore, in this case also for each point or each voxel of the internal structure it is clear whether it is used for simulating a blood vessel or for simulating a blood vessel-free gum section.

Furthermore, the object is achieved by a dental prosthesis base which has an outer shell and an internal structure, wherein the internal structure is determined by means of a method in accordance with the invention for determining an internal structure of a dental prosthesis base and/or wherein the dental prothesis base is manufactured using a method according to the invention for the production of a dental prothesis base. The internal structure of such a dental prosthesis base thus contains at least one blood vessel simulation. This imparts a natural appearance to the dental prosthesis base. In addition, the fact that the dental prosthesis base has an internal structure which is determined by means of a method according to the invention for determining an internal structure of a dental prosthesis base and/or the fact that the dental prosthesis base is manufactured by means of a method according to the invention for manufacturing a dental prosthesis base means that the at least one blood vessel simulation is produced by means of a material which differs in at least one of the selected material, color, color brightness and translucency from the material by means of which the remaining portions of the dental prosthesis base are produced. Beyond that, the material from which the at least one blood vessel simulation is made can be the same as the material from which the remaining portions of the dental prosthesis base are made. Preferably, the dental prosthesis base is made of a plastics material. This applies to the dental prosthesis base as a whole, i.e. preferably the at least one blood vessel simulation is also made of a plastics material. Consequently, the dental prosthesis base according to the invention can also be distinguished from a structural point of view from known dental prosthesis bases which comprise a fiber material with a plurality of reddish-colored fibers for replicating blood vessels. A dental prosthesis base according to the invention does not comprise any fiber material.

In a case in which the dental prosthesis base is manufactured using an additive or generative manufacturing process, the dental prosthesis base can be given a particularly natural appearance. Dental prosthesis bases produced in this way can be distinguished from known dental prosthesis bases, for example, by viewing them with a microscope or magnifying glass. This is due to the fact that characteristic features of the additive or generative manufacturing process can be seen using the microscope or magnifying glass. This applies in particular to the at least one blood vessel simulation, the structure of which therefore also differs from known blood vessel simulations comprising fiber material from a structural point of view. The microscope or magnifying glass can be used for external observation. Alternatively or additionally, it is possible to cut through or into the dental prosthesis base and view the resulting cut surface using the microscope or magnifying glass. The characteristic features can be recognized particularly well in the cut surface.

Moreover, the object is achieved by a data-processing device. The data-processing device comprises means for carrying out the method in accordance with the invention for determining an internal structure of a dental prosthesis base. Such a data-processing device can therefore be used to determine an internal structure of the dental prosthesis base which comprises at least one blood vessel simulation. The internal structure preferably contains a plurality of blood vessel simulations. This imparts a natural appearance to the dental prosthesis base.

Since in the present case all the steps of the method for determining an internal structure of a dental prosthesis base can be carried out entirely by computer program instructions on means which, in the context of the invention, perform general data processing functions, the data-processing device can be a general data processing device which is specifically configured to carry out the method for determining an internal structure of a dental prosthesis base. For example, the data processing device is a personal computer (PC), a server computer, a smartphone or a tablet computer. In this context, obtaining outer shell data and obtaining blood vessel data can be done via standard interfaces of such general data processing means, e.g. USB interfaces or common network interfaces. Further, combining the outer shell data and the blood vessel data into internal structure data is a computing operation that can be performed by such general data processing means.

The object is also achieved by a computer program which comprises commands which, when the computer program is being executed by a computer, cause this computer to carry out the method in accordance with the invention for determining an internal structure of a dental prosthesis base. Such a computer program can therefore be used to determine an internal structure of the dental prosthesis base which comprises at least one blood vessel simulation. The internal structure preferably contains a plurality of blood vessel simulations. This imparts a natural appearance to the dental prosthesis base.

The object is additionally achieved by a computer-readable medium or product which comprises commands which, when executed by a computer, cause this computer to carry out the method in accordance with the invention for determining an internal structure of a dental prosthesis base. The computer program product includes program code which is stored on a non-transitory machine-readable medium, the machine-readable medium comprising computer instructions executable by a processor to carry out the method of the invention. Such a computer-readable medium can therefore be used to determine an internal structure of the dental prosthesis base which comprises at least one blood vessel simulation. The internal structure preferably contains a plurality of blood vessel simulations. This imparts a natural appearance to the dental prosthesis base.

It is understood that the effects, advantages and features mentioned above in conjunction with one of a method in accordance with the invention for determining an internal structure of a dental prosthesis base, a method in accordance with the invention for the production of a dental prosthesis base, a dental prosthesis base in accordance with the invention, a data processing device in accordance with the invention, a computer program in accordance with the invention and a computer-readable medium in accordance with the invention apply analogously for all other ones of a method in accordance with the invention for determining an internal structure of a dental prosthesis base, a method in accordance with the invention for the production of a dental prosthesis base, a dental prosthesis base in accordance with the invention, a data processing device in accordance with the invention, a computer program in accordance with the invention and a computer-readable medium in accordance with the invention.

### BRIEF DESCRIPTION OF THE DRAWINGS

The invention will be explained hereinafter with the aid of various exemplified embodiments which are illustrated in the attached drawings. In the drawings:

FIG. 1 shows a data-processing device in accordance with the invention having a computer-readable medium in accordance with the invention and having a computer program in accordance with the invention, wherein the data-processing device is designed to carry out a method in accordance with the invention for determining an internal structure of a dental prosthesis base and wherein the data-processing device is coupled to a production device so that a dental prosthesis base in accordance with the invention can be produced using a method in accordance with the invention for the production of a dental prosthesis base,

FIG. 2 shows a dental prosthesis base in accordance with the invention, the internal structure of which is determined by means of a method in accordance with the invention for determining an internal structure of a dental prosthesis base, and which is produced by means of a method in accordance with the invention for the production of a dental prosthesis base, wherein the dental prosthesis base is illustrated realistically in FIG. 2a) and is illustrated schematically in FIG. 2b).

FIG. 3 shows an illustration of a first embodiment of the method in accordance with the invention for determining an internal structure of a dental prosthesis base,

FIG. 4a shows a visualization of one option of blood vessel data which can be used in the method in accordance with the invention for determining an internal structure of a dental prosthesis base,

FIG. 4b shows a visualization of different alternative blood vessel data which can be used in the method in accordance with the invention for determining an internal structure of a dental prosthesis base,

FIG. 4c shows a visualization of different alternative blood vessel data which can be used in the method in accordance with the invention for determining an internal structure of a dental prosthesis base,

FIG. 4d shows a visualization of different alternative blood vessel data which can be used in the method in accordance with the invention for determining an internal structure of a dental prosthesis base,

FIG. 4e shows a visualization of different alternative blood vessel data which can be used in the method in accordance with the invention for determining an internal structure of a dental prosthesis base,

FIG. 5 shows a visualization of one option of generating blood vessel data,

FIG. 6 shows a visualization of a further option of generating blood vessel data,

FIG. 7 shows an illustration of a second embodiment of the method in accordance with the invention for determining an internal structure of a dental prosthesis base,

FIG. 8 shows a further dental prosthesis base in accordance with the invention, the internal structure of which is determined by means of a method in accordance with the invention for determining an internal structure of a dental prosthesis base, and which is produced by means of a method in accordance with the invention for the production of a dental prosthesis base,

FIG. 9 shows yet another dental prosthesis base in accordance with the invention, the internal structure of which is determined by means of a method in accordance with the invention for determining an internal structure of a dental prosthesis base, and which is produced by means of a method in accordance with the invention for the production of a dental prosthesis base,

FIG. 10 shows an overview of data processed during the method in accordance with the invention for determining an internal structure, and

FIG. 11 shows an overview of method steps of the method in accordance with the invention for the production of a dental prosthesis base and of method steps of the method in accordance with the invention for determining an internal structure.

### DETAILED DESCRIPTION

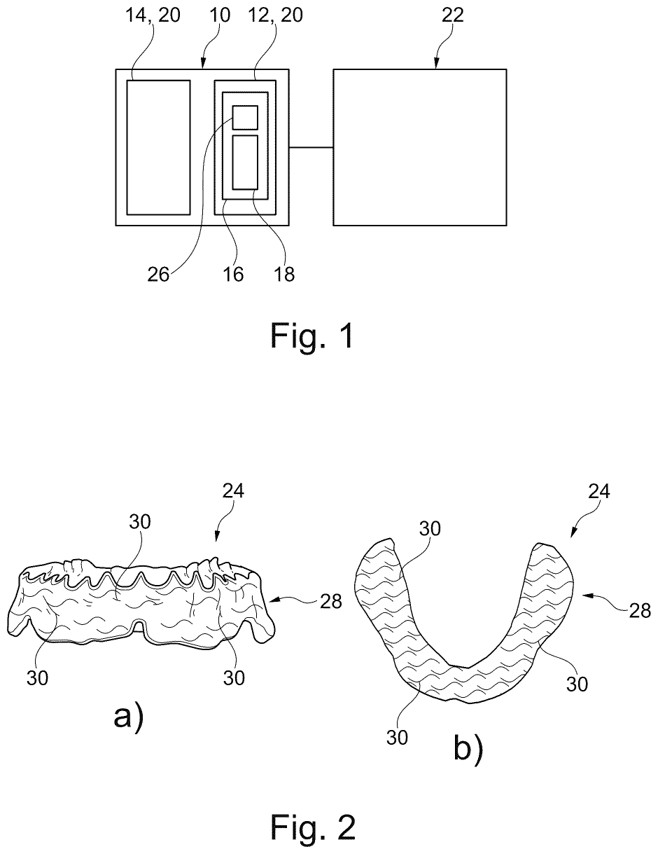

FIG. 1 shows a data-processing device 10.

This comprises a memory unit 12 and a computing unit 14.

The memory unit 12 comprises a computer-readable medium 16.

A computer program 18 is stored on the computer-readable medium 16, i.e. also in the memory unit 12.

The computer program 18 and therefore also the computer-readable medium 16 comprise commands which, when the computer program 18 is being executed by the computing unit 14 or, more generally speaking, by a computer, cause the computing unit 14 or the computer to carry out a method for determining an internal structure of a dental prosthesis base.

Consequently, the memory unit 12 and the computing unit 14 constitute means 20 for carrying out the method for determining an internal structure of a dental prosthesis base.

In the example of FIG. 1, the data-processing device 10 is further coupled to a production device 22 by communications technology. The production device 22 is designed to produce a dental prosthesis base 24 which comprises an internal structure which has been determined by means of the method for determining the internal structure of the dental prosthesis base 24.

For this reason, the memory unit 12 in the illustrated exemplified embodiment additionally comprises a computer program 26 for actuating the production device 22. In other words, the computer program 26 comprises commands which, when the computer program 26 is being executed by the computing unit 14 or, more generally speaking, by a computer, cause the computing unit 14 or the computer to control the production device 22.

In the example of FIG. 1, the production device 22 is designed to produce the dental prosthesis base 24 additively or generatively. In simpler terms, the production device 22 can thus be designated as a 3D printer.

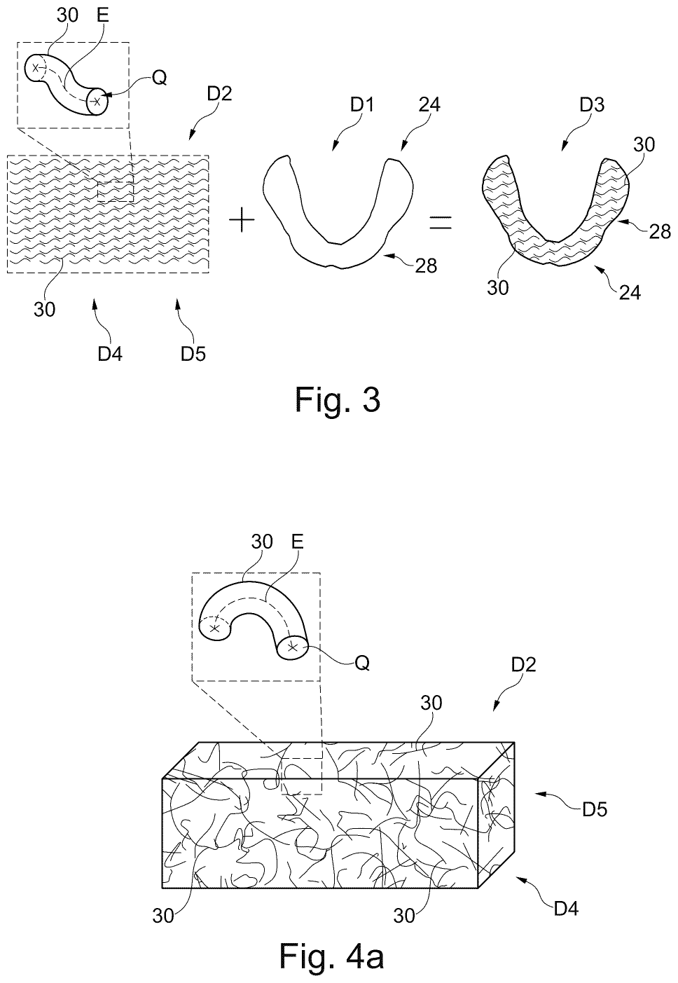

The method for the production of the dental prosthesis base 24 will be explained in detail hereinafter with reference to FIGS. 2 and 3 (see also FIG. 11).

The dental prosthesis base 24 which results from the application of the method and thus includes at least one blood vessel simulation 30 is illustrated in FIG. 2. As already mentioned, FIG. 2a) shows a realistic image of the dental prosthesis base 24 and FIG. 2b) shows a schematic illustration.

The dental prosthesis base 24 contains a plurality of blood vessel simulations 30, wherein for improved clarity only a few of them are provided with a reference sign. It is understood that the blood vessel simulations 30 of the dental prosthesis base 24 in FIG. 2 are schematic in nature.

The method for the production of the dental prosthesis base initially comprises, in a first step S01, determining an internal structure of the dental prosthesis base 24. A method for determining an internal structure of a dental prosthesis base 24 is used for this purpose.

In the present case, the steps of the method for the production of the dental prosthesis base are designated as S01 and S02. The steps for the method for determining an internal structure of the dental prosthesis base are designated as S1 to S6.

A first step S1 of the method for determining an internal structure of the dental prosthesis base 24 comprises obtaining outer shell data D1 which describe an outer shell 28 of the dental prosthesis base 24. An example of an outer shell 28 of the dental prosthesis base 24 is graphically represented in FIG. 2. The outer shell data DI can also be seen in FIG. 3.

The outer shell data D1 can include a coordinate system which can be used to describe the outer shell data D1 in more detail.

In such a coordinate system, the origin can be placed into a center of mass or center of volume of the outer shell 28.

A second step S2 of the method for determining an internal structure of the dental prosthesis base 24 comprises obtaining blood vessel data D2 which, in the illustrated example, describe a plurality of blood vessel simulations 30. These are distributed in three spatial dimensions. The blood vessel data D2 thus describe a volume in which a plurality of blood vessel simulations 30 are arranged.

The blood vessel data D2 can be seen in FIG. 3.

The blood vessel data D2 describe each of the blood vessel simulations 30 with the aid of geometric parameters.

In this context, each blood vessel simulation 30 is designed as a cross-section Q running along a path E in the manner of an extrusion.

This means that a first geometric parameter P1 describes the cross-section Q of a blood vessel simulation 30. In the illustrated example, the cross-section Q is in the shape of a circular disc. The cross-section Q can be described for example using a center point and a radius. The center point can be expressed for example in a coordinate system of the blood vessel data D2.

A second geometric parameter P2 describes the path E along which the cross-section Q runs in the manner of an extrusion. In the present case, this path E is also expressed by means of coordinates of the coordinate system of the blood vessel data D2.

In the present example, all of the blood vessel simulations 30 of the plurality of blood vessel simulations 30 are identical in shape. Therefore, all of the blood vessel simulations 30 can be described by means of the first geometric parameter P1 and the second geometric parameter P2.

A third step S3 of the method for determining the internal structure further comprises obtaining density information D4 which describes a spatial packing density of the blood vessel simulations 30.

In other words, in the third step S3 information is obtained which indicates how the blood vessel simulations 30 described by means of the blood vessel data D2 are spatially arranged. An example of a spatial arrangement can be seen in FIG. 3.

Even though the second step S2 and the third step S3 have been described separately in the present case, it is possible for these steps S2, S3 to be performed in a combined manner. In this context, the blood vessel data D2 for example can also comprise density information D4. This density information D4 can be provided implicitly.

In an optional fourth step S4, scaling information D5 is also obtained. On the basis thereof, at least one dimension of the at least one blood vessel simulation 30 described by the blood vessel data D2 is scaled. In the present example, in this manner for example a radius of the extruded cross-section Q or a length of the path E, along which the cross-section Q runs in the manner of an extrusion, can be scaled.

After completion of the first step S1, the second step S2, the third step S3 and the fourth step S4, the blood vessel simulations 30 are thus fully defined in terms of their shape, which also implies their size, and in terms of their position in space. In this respect, the blood vessel data D2 are combined with the density information D4 and the scaling information D5.

FIG. 3 shows a visualization of such blood vessel simulations 30 and their position in space.

In a fifth step S5, the outer shell data D1 and the blood vessel data D2 are combined to form internal structure data D3.

Boolean operations are used for this purpose.

In this context, the blood vessel data D2 are initially divided into two parts by means of the outer shell data D1. A first part relates to blood vessel data D2 which describe blood vessel simulations in the interior of the outer shell 28 described by the outer shell data D1. This part of the blood vessel data D2 can also be referred to as reduced blood vessel data. The other part accordingly describes blood vessel simulations which lie outside the outer shell described by the outer shell data D1. The latter part is ignored. It is understood that for this purpose the volume in which the blood vessel simulations 30 are arranged must be big enough that the volume of the dental prosthesis base 24 can be completely received therein.

It is also understood that in this manner a combination of blood vessel data D2, density information D4 and scaling information D5 is implicitly divided into two parts by means of the outer shell data D1.

Then, the blood vessel simulations described by the reduced blood vessel data are subtracted from the volume described by the outer shell data D1. This results in a volume which is delimited outwardly from the outer shell 28 and in the interior comprises empty spaces at those locations at which blood vessel simulations 30 are to be provided. The associated data can be referred to as reduced outer shell data.

Subsequently, the reduced blood vessel data are united with the reduced outer shell data, thus producing the internal structure data D3.

The preceding steps are illustrated in FIG. 3 in a simplified manner as an addition sum.

As a result, internal structure data D3 are produced which describe an internal structure of a dental prosthesis base 24 according to FIG. 2. The internal structure data thus describe an arrangement of the blood vessel simulations 30 within the outer shell 28 of the dental prosthesis base 24. Each point or each voxel of the internal structure is clearly allocated to a blood vessel simulation 30 or a section of a gum simulation which is not used for simulating a blood vessel.

Subsequently, in a sixth step S6 color information, color brightness information, material information and translucency information are allocated to the blood vessel simulations 30 described by the blood vessel data D2.

This means that it is established in which color, with which color brightness, from which material and with which translucency the blood vessel simulations 30 are produced.

Furthermore, color information, color brightness information, material information and translucency information are allocated to the remaining sections of the dental prosthesis base 24, i.e. the sections of the dental prosthesis base 24 which do not represent blood vessel simulations 30.

On the basis thereof, the dental prosthesis base can be produced in a second step S02 of the method for the production of the dental prosthesis base 24.

The blood vessel simulations 30 are fabricated by means of a substance which differs in terms of at least one property selected from material, color, color brightness and translucency from the substance by means of which the remaining sections of the dental prosthesis base 24 are fabricated.

As already mentioned, in the present example an additive fabricating method is used which can be performed using the production device 22.

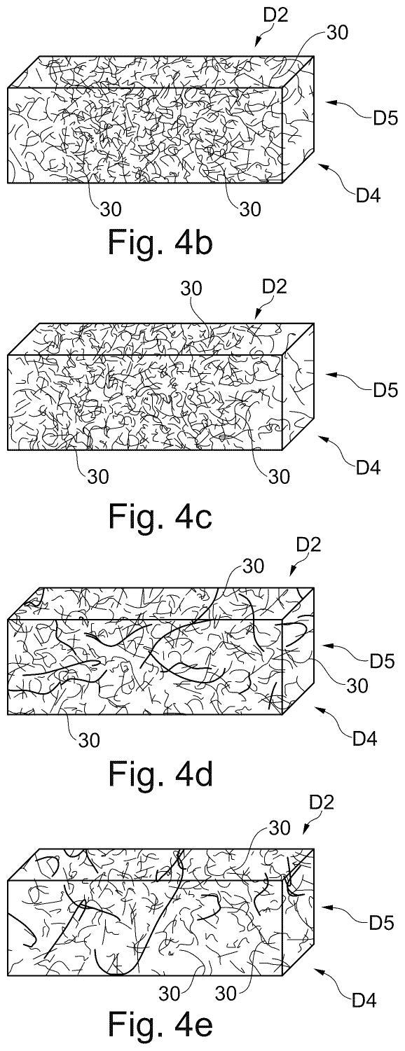

FIGS. 4a through 4e show several alternative blood vessel data D2 which can be used instead of the blood vessel data D2 shown in FIG. 3 in the method for determining an internal structure of the dental prosthesis base 24. Density information D4 and scaling information D5 are also considered.

The blood vessel data D2 from the variants according to FIG. 4 differ from the blood vessel data D2 of FIG. 3 by virtue of the fact that in the blood vessel data D2 of FIG. 4 none of the blood vessel simulations 30 described thereby are identical.

In other words, the blood vessel data D2 of all the variants according to FIG. 4 describe a plurality of blood vessel simulations 30, wherein each of the blood vessel simulations 30 is unique. For improved clarity, again only some of the blood vessel simulations 30 are provided with a reference sign in the visualizations.

In all the variants according to FIG. 4, the blood vessel data D2 contain method parameters P3 which describe a process for generating the blood vessel simulations 30.

This means that in the variants according to FIG. 4, the blood vessel data D2 do not directly describe the actual geometry of the blood vessel simulations 30 but merely refer to this process for generating the blood vessel simulations 30.

This process comprises several steps which in the present case are initially explained for the variant from FIG. 4a).

In a first step, starting points or anchor points for blood vessel simulations 30 are established in a random manner. As a boundary condition, a predetermined minimum distance is considered, which is 4 mm to 6 mm for example. In this context, density information D4 can also be considered, as already explained in conjunction with the exemplified embodiment of FIG. 3.

Then, starting from each starting point an associated blood vessel simulation 30 is determined by an extrusion method.

A cross-section Q for the blood vessel simulation 30 is again established and is in the shape of a circular disc.

However, in the example of FIG. 4a) a shape of the path E, along which the cross-section Q runs, is random.

This relates on the one hand to a length of the path E which is randomly selected within a predefined length range.

In the example according to FIG. 4, the path E can also comprise one or more curves. The number of curves and the position and an associated curve radius are also randomly determined.

The blood vessel simulations 30 described by these blood vessel data D2 are shown in FIG. 4, wherein an exemplified blood vessel simulation 30 is illustrated in an enlarged manner.

For the remainder, reference can be made to the above explanations.

In the variant of FIG. 4b), the blood vessel simulations 30 are determined by means of the same process, wherein, however, different parameters from those used in FIG. 4a) are used.

For a start, the minimum distance, which in the variant of FIG. 4b) is considered when randomly establishing the starting or anchor points, is smaller than in the variant of FIG. 4a). In other words, in the variant of FIG. 4b) the density information D4 describes a more compact arrangement of the blood vessel simulations 30.

Furthermore, a cross-section Q of the blood vessel simulations in the variant of FIG. 4b) is smaller than in the variant of FIG. 4a). This can be seen by virtue of the fact that the lines which represent the blood vessel simulations 30 are thinner.

Also in the variant of FIG. 4b), the blood vessel simulations 30 are again determined by an extrusion method.

The shape of the path E, along which the cross-section Q runs, is again random. However, in contrast to the variant of FIG. 4a) the predefined range for the length is smaller.

The number of curves and the position and an associated curve radius are again randomly determined, wherein these parameters in the variant of FIG. 4b) substantially correspond to those in the variant of FIG. 4a).

Compared with the variant of FIG. 4b), in the variant of FIG. 4c) only the minimum distance considered when randomly establishing the starting or anchor points is selected to be somewhat larger. The blood vessel simulations 30 are thus arranged slightly less compactly. Otherwise, the same process parameters were used.

The fact that the blood vessel simulations 30 in the variants of FIG. 4b) and FIG. 4c) are not identical is due to the influence of the randomness when positioning the starting or anchor points and the shape and size of the blood vessel simulations 30.

The variants of FIGS. 4d) and 4e) differ from the already mentioned variants of FIG. 4 to the effect that different cross-sections Q are now used for the blood vessel simulations 30. This can be seen by virtue of the fact that the lines which represent the blood vessel simulations 30 have different thicknesses.

Furthermore, in the variants of FIGS. 4d) and 4e) a longer length is also permitted for the blood vessel simulations 30 with larger cross-sections Q, i.e. the allocated predefined range for the length relates to longer lengths.

Optionally, in the method for determining the internal structure of the dental prosthesis base 24, obtaining blood vessel data D2 also comprises selecting the blood vessel data D2 from a plurality of blood vessel data alternatives. Each blood vessel data alternative describes at least one blood vessel simulation 30. In the present example, each blood vessel data alternative describes a plurality of blood vessel simulations 30. For example, a first blood vessel data alternative describes blood vessel simulations 30 as illustrated in FIG. 3. For example, a second blood vessel data alternative describes blood vessel simulations 30 as illustrated in FIG. 4a). For example, a third blood vessel data alternative describes blood vessel simulations 30 as illustrated in FIG. 4b). For example, a fourth blood vessel data alternative describes blood vessel simulations 30 as illustrated in FIG. 4c). For example, a fifth blood vessel data alternative describes blood vessel simulations 30 as illustrated in FIG. 4d). For example, a sixth blood vessel data alternative describes blood vessel simulations 30 as illustrated in FIG. 4e).

The blood vessel data alternatives can be provided in the form of a library.

A user of the method for determining the internal structure of the dental prosthesis base 24 can thus select the desired blood vessel data alternative from such a library. In the present case, the user would thus select between the blood vessel data D2 according to FIG. 3 and the blood vessel data D2 according to the different variants of FIGS. 4a-4e.

Alternatively, a blood vessel data alternative can be selected from multiple blood vessel data alternatives in an automated manner.

FIG. 5 describes a further alternative for creating blood vessel data D2.

In this alternative, the blood vessel data D2 are generated starting from a description of a single blood vessel simulation 30.

Such a blood vessel simulation 30 can also be described as a template or model.

In the example of FIG. 5, the blood vessel data D2 describe an arcuate blood vessel simulation 30. This can be described by a radius of curvature R and by a length L.

Starting from this template or this model, further blood vessel data elements can be generated which describe blood vessel simulations 30 which differ from the model by virtue of the fact that they have a different radius of curvature R and/or a different length L.

In this context, a blood vessel simulation 30 can be seen in FIG. 5(a) in which starting from the template the radius of curvature R has been kept the same but the length L has been shortened.

FIG. 5(b) shows a blood vessel simulation 30, in which starting from the template the radius of curvature R has been kept the same but the length L has been increased.

FIG. 5(c) shows a blood vessel simulation 30 in which starting from the template the radius of curvature R has been reduced. The length L has not been altered compared with the template.

Blood vessel data D2 which describe such different blood vessel simulations 30 can then be arranged, similar to as already explained, at spatially distributed starting points or anchor points.

Based thereon, the blood vessel data D2 can be combined with outer shell data D1 e.g., utilizing a Boolean operation, as already explained.

FIG. 6 describes a further alternative for creating blood vessel data D2.

In this alternative, the blood vessel data D2 are again generated starting from a description of a single blood vessel simulation 30 which again can be described as a template or model.

In the example of FIG. 6, the blood vessel data D2 describe an S-shaped blood vessel simulation 30, i.e. a blood vessel simulation 30 which is substantially composed of two circular arc segments having opposite curvatures.

In the example of FIG. 6, further blood vessel data elements describing further blood vessel simulations 30 are derived utilizing scaling information D5. At least one dimension of the blood vessel simulation 30 is always scaled starting from the model.

In this context, the variant in FIG. 6(a) describes a blood vessel simulation 30 which has been produced by a compression of dimension a.

The variant in FIG. 6(b) describes a blood vessel simulation 30 which has been produced by a stretching of dimension a.

The variant in FIG. 6(c) shows a blood vessel simulation 30 which has been produced by a shortening, i.e. a proportional compression, of dimensions a and b.

The variant in FIG. 6(d) shows a blood vessel simulation 30 which has been produced by an enlargement, i.e. a proportional stretching, of dimensions a and b.

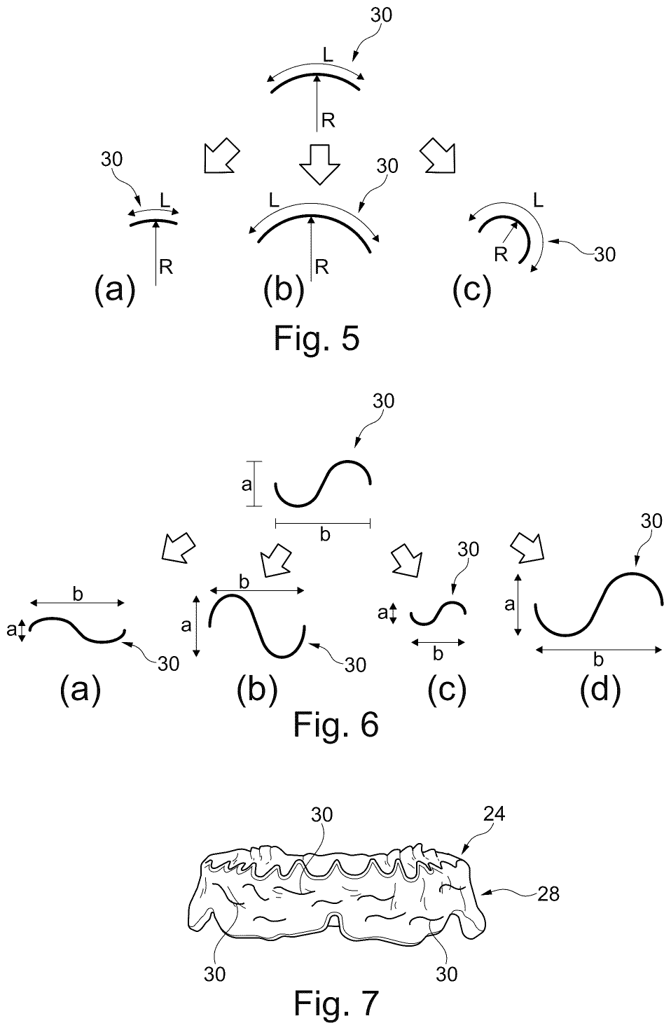

FIG. 7 illustrates a second embodiment of the method for determining a structure of the dental prosthesis base 24,

In contrast to the previously described examples, combining the outer shell data D1 and the blood vessel data D2 in the second exemplified embodiment comprises exclusively using the blood vessel data D2 within the outer shell 28 described by the outer shell data D1. Therefore, no Boolean operation takes place. Rather, to put it simply, the volume of the dental prosthesis base 24 delimited by the outer shell 28 is filled with blood vessel simulations 30.

This means that in a case in which blood vessel data D2 describe the blood vessel simulations 30 using geometric parameters, the blood vessel data D2 are combined with the outer shell data D1 such that the blood vessel simulations 30 always lie in the interior of the outer shell 28 described by the outer shell data D1.

In such a case, starting or anchor points can be provided in the interior of the outer shell and a blood vessel simulation 30 can be allocated to each starting or anchor point, said simulation preferably also being positioned relative to the allocated starting or anchor point.

There are several alternatives for the provision of the starting or anchor points.

According to a first alternative, the starting or anchor points can be provided as points of a regular or irregular grid.

According to a second alternative, the starting or anchor points are arranged randomly in the interior of the outer shell 28. Minimum distances can be predetermined as boundary conditions, as already explained further above.

For the case that the blood vessel data D2 describe the blood vessel simulations 30 using method parameters, the same applies. This means that the blood vessel simulations 30 are generated such that they always lie in the interior of the outer shell 28 described by the outer shell data D1.

For this purpose, the processes explained with the aid of the variants of FIG. 4 can be used, wherein, however, these are exclusively applied to the volume of the dental prosthesis base 24 delimited by the outer shell 28. In this manner, the determination of an intersection of the volume of the dental prosthesis base 24 and a volume in which the blood vessel simulations 30 are arranged can be omitted.

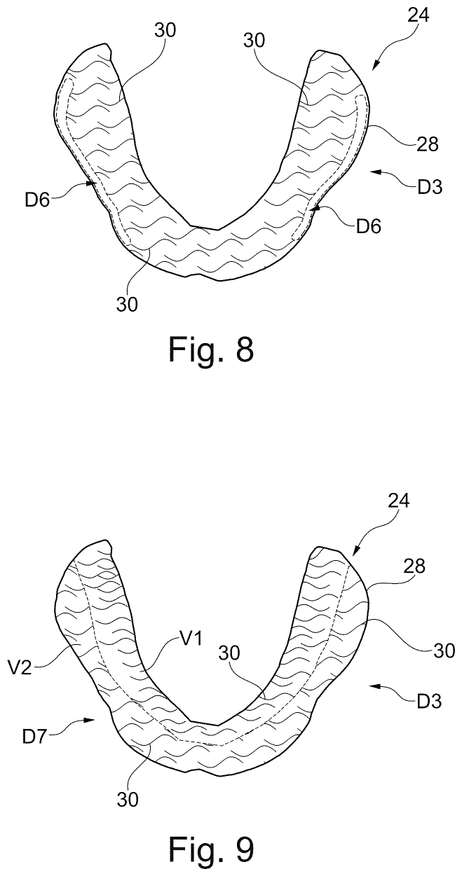

As an option, in all of the above-mentioned variants and embodiments of the method for determining an internal structure of the dental prosthesis base 24, block-out data D6 can be obtained. This is explained hereinafter with the aid of FIG. 8 which shows this.

The block-out data D6 describe at least one blood vessel-free section within the outer shell 28 of the dental prosthesis base 24. This means that the block-out data D6 define at least one section in which no blood vessel simulations 30 are arranged.

These block-out data D6 are then combined with the outer shell data D1 and the blood vessel data D2 to form internal structure data D3.

In this manner, the internal structure data D3 describe merely blood vessel simulations 30 for sections of the dental prosthesis base 24 which lie within the outer shell 28 of the dental prosthesis base 24 and outside the at least one blood vessel-free section described by the block-out data D6.

In one example, in this manner a boundary layer of the dental prosthesis base 24 is generated which is free of blood vessel simulations 30.

In FIG. 8, two sections of such a boundary layer are shown which are free of blood vessel simulations 30. It is understood that these sections are shown purely by way of example.

According to a further option which is compatible with all the explained variants and embodiments of the method for determining an internal structure, sub-volume data D7 are obtained during the method for determining an internal structure. This will be explained hereinafter with reference to FIG. 9.

The sub-volume data D7 each describe a section of the dental prosthesis base 24 described by the outer shell data D1.

On this basis, the outer shell data D1, the sub-volume data D7 and the blood vessel data D2 can be combined to form internal structure data D3 and so the internal structure data D3 describe an arrangement of the at least one blood vessel simulation 30 within the section of the dental prosthesis base 24 described by the sub-volume data D7.

Therefore, to put it simply, blood vessel simulations 30 are provided only within the sub-volume described by means of the sub-volume data D7.

In one variant, sub-volume data D7 are obtained which describe different sub-volumes, i.e. different sections of the dental prosthesis base 24 described by the outer shell data D1. Preferably, the different sub-volumes are free of overlap. In such a case, the blood vessel simulations 30 may be different in each of these sub-volumes. For example, the blood vessel simulations 30 can differ in terms of their shape and/or in terms of their spatial packing density.

In the example of FIG. 9, the blood vessel simulations 30 in sub-volume V1 are provided with a higher packing density than those in sub-volume V2. Sub-volume V1 and sub-volume V2 are described by the sub-volume data D7.

It is again understood that the illustration in FIG. 9 is shown purely by way of example.

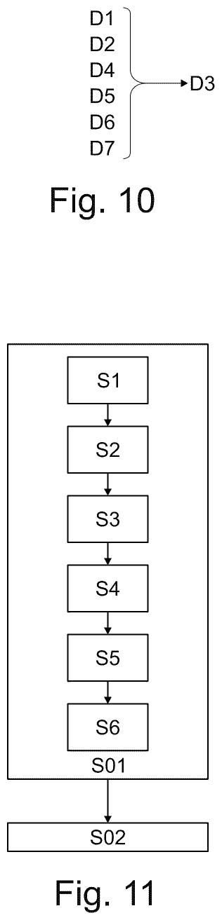

The cooperation of the outer shell data D1, the blood vessel data D2, the density information D4, the scaling information D5, the block-out data D6 and the sub-volume data D7 when creating the internal structure data D3 is summarized in FIG. 10.

In addition, the steps of the method for the production of the dental prosthesis base 24 and the steps of the method for determining an internal structure of the dental prosthesis base 24 are summarized in FIG. 11.

### LIST OF REFERENCE SIGNS

10 data-processing device
12 memory unit
14 computing unit
16 computer-readable medium
18 computer program
20 means for carrying out a method for determining an internal structure of a dental prosthesis base
22 production device
24 dental prosthesis base
26 computer program
28 outer shell
30 blood vessel simulation
a dimension
b dimension
D1 outer shell data
D2 blood vessel data
D3 internal structure data
D4 density information
D5 scaling information
D6 block-out data
D7 sub-volume data
E path
L length
P1 first geometric parameter
P2 second geometric parameter
P3 method parameter
Q cross-section
R radius of curvature
S01 first step of the method for the production of a dental prosthesis base
S02 second step for the production of a dental prosthesis base
S1 first step of a method for determining an internal structure of a dental prosthesis base
S2 second step of a method for determining an internal structure of a dental prosthesis base
S3 third step of a method for determining an internal structure of a dental prosthesis base
S4 fourth step of a method for determining an internal structure of a dental prosthesis base
S5 fifth step of a method for determining an internal structure of a dental prosthesis base
S6 sixth step of a method for determining an internal structure of a dental prosthesis base
V1 sub-volume
V2 sub-volume

1. A method for determining an internal structure of a dental prosthesis base (24) imitating an appearance of at least one blood vessel (30), comprising:
obtaining outer shell data (D1) which describe an outer shell (28) of the dental prosthesis base (24) (S1),
obtaining blood vessel data (D2) which describe at least one blood vessel replica (30) (S2), and
combining the outer shell data (D1) and the blood vessel data (D2) to form internal structure data (D3), wherein the internal structure data (D3) describe an arrangement of the at least one blood vessel replica (30) within the outer shell (28) of the dental prosthesis base (24) (S5).

2. The method as claimed in claim 1, wherein combining the outer shell data (D1) and the blood vessel data (D2) to form internal structure data (D3) includes a Boolean operation and/or wherein combining the outer shell data (D1) and the blood vessel data (D2) to form internal structure data (D3) includes exclusively using the blood vessel data (D2) within the outer shell (28) of the dental prosthesis base (24) described by the outer shell data (D1).

3. The method as claimed in claim 1, wherein the blood vessel data (D2) contain at least one geometric parameter (P1, P2) which describes a geometry of the blood vessel (30) replica, and/or wherein the blood vessel data (D2) contain at least one method parameter (P3) which describe a process for creating the blood vessel replica (30).

4. The method as claimed in claim 1, wherein the at least one blood vessel replica (30) is described as a cross-section (Q) running along a path (E) in the manner of an extrusion.

5. The method as claimed in claim 1, wherein the blood vessel data (D2) describe a plurality of blood vessel replicas (30), wherein the blood vessel replicas (30) are distributed in three dimensions.

6. The method as claimed in claim 5, further comprising
obtaining density information (D4) which describes a spatial packing density of the blood vessel replicas (30) (S3), and
combining the density information (D4) and the blood vessel data (D2) so that the plurality of blood vessel replicas (30) are distributed in three dimensions with the spatial packing density.

7. The method as claimed in claim 1, further comprising
obtaining scaling information (D5) and scaling, on the basis of the scaling information (D5), at least one dimension of the at least one blood vessel replica (30) described by the blood vessel data (D2) (S4).

8. The method as claimed in claim 1, further comprising
allocating color information to the at least one blood vessel replica (30) described by the blood vessel data (D2), and/or
allocating color brightness information to the at least one blood vessel replica (30) described by the blood vessel data (D2), and/or
allocating material information to the at least one blood vessel replica (30) described by the blood vessel data (D2), and/or
allocating translucency information to the at least one blood vessel replica (30) described by the blood vessel data (D2) (S6).

9. The method as claimed in claim 1, further comprising
obtaining block-out data (D6) which describe at least one blood vessel-free section within the outer shell (28) of the dental prosthesis base (24), and
combining the outer shell data (D1) and the blood vessel data (D2) to form internal structure data (D3) for sections within the outer shell (28) of the dental prosthesis base (24) and outside the at least one blood vessel-free section described by the block-out data (D6).

10. The method as claimed in claim 1, further comprising
obtaining sub-volume data (D7) which describe a section of an interior of the outer shell (28) of the dental prosthesis base (24) described by the outer shell data (D1),
combining the outer shell data (D1), the sub-volume data (D7) and the blood vessel data (D2) to form internal structure data (D3), wherein the internal structure data (D3) describe an arrangement of the at least one blood vessel replica (30) within the section of the interior of the outer shell (28) of the dental prosthesis base (24) described by the sub-volume data (D7).

11. The method as claimed in claim 1, wherein obtaining blood vessel data (D2) includes selecting the blood vessel data (D2) from a plurality of blood vessel data alternatives, wherein each of the blood vessel data alternatives describes at least one blood vessel replica (30).

12. A method for the production of a dental prosthesis base (24) with a predetermined outer shell (28) and having at least one blood vessel replica (30), comprising:
determining an internal structure of the dental prosthesis base (24) by means of the method as claimed in claim 1 (S01), and
fabricating the dental prosthesis base (24) with the determined internal structure, wherein the at least one blood vessel replica (30) is fabricated by means of a substance which differs in terms of at least one property selected from material, color, color brightness and translucency from the substance by means of which the remaining sections of the dental prosthesis base (24) are fabricated (S02).

13. The method as claimed in claim 12, wherein an additive fabricating method is used to fabricate the dental prosthesis base (24) with the determined internal structure.

14. A dental prosthesis base (24) with an outer shell (28) and an internal structure, wherein the internal structure is determined by the method as claimed in claim 1.

15. A data-processing device (10) comprising a memory unit (12) and a computing unit (14) for carrying out the method as claimed in claim 1.

16. A computer program (18) comprising commands which, when the computer program (18) is executed by a computer, cause the computer to carry out the method as claimed in claim 1.

17. A computer program product (16) comprising program code which is stored on a non-transitory machine-readable medium, the machine-readable medium comprising computer instructions executable by a computer to carry out the method as claimed in claim 1.
